(19) United States
(12) Patent Application Publication
(10) Pub. No.: US 2011/0308361 A1
(43) Pub. Date: Dec. 22, 2011

(54) Ergonomic Cutting Board

(76) Inventor: Edgar Hugo, Aventura, FL (US)

(21) Appl. No.: 12/819,180

(22) Filed: Jun. 19, 2010

(51) Int. Cl. B26D 1/00; B23Q 3/00

(52) U.S. Cl. 83/13; 269/289 R

(57) ABSTRACT

A cutting board that can be dried without having to rest the cutting board's cutting surface on a kitchen surface and that further allows the user to handle the cutting board comfortably. The cutting board has a substantially planar portion and an acute angled rear portion. The acute angled rear portion of the cutting board is used to stand the cutting board upward after the washing of the cutting board. By standing the cutting board, any liquid on the cutting board will drip toward the surface in which the cutting board stands on. By allowing the board to be dried in this manner, contamination of the board's cutting surface is minimized.

### BACKGROUND

The present invention is directed toward cutting boards used in residential kitchens.

The inventor of the present invention conceived his invention while cooking. He noticed that after he used his cutting board that he always had to clean it. He normally cleaned the cutting board by cleaning it in his kitchen sink and after cleaning the cutting board he always had to somehow dry the cutting board. He dried the Cutting board by either resting the cutting board on another kitchenware or by placing the cutting board flat on one of its cutting faces on a kitchen surface. He realized that this was not a very hygienic, for most cutting boards have two identical sides and one side would always be in contact with the kitchen surface.

He also realized that cutting boards are extremely difficult to pick up once they are placed on a flat surface, especially if the surface is wet.

The present invention addresses the above two problems. The cutting board of the present invention allows a user to dry a cutting board without having to place one of its faces on a surface and it is also easy to handle.

Accordingly, there is a need for an ergonomic cutting board that can be dried without having to rest the cutting board's cutting surface on a kitchen surface and that further allows the user to pick up the cutting board comfortably.

### SUMMARY

The present invention is directed to an portable an ergonomic cutting board that can be dried without having to rest the cutting board's cutting surface on a kitchen surface and that further allows the user to pick up the cutting board comfortably.

The cutting board of the present invention has a substantially planar portion and an acute angled rear portion. The acute angled rear portion of the cutting board is used to stand the cutting board upward after the washing of the cutting board. By standing the cutting board, any liquid on the cutting board will drip toward the surface in which the cutting board stands on. By allowing the board to be dried in this manner, contamination of the board's cutting surface is minimized.

An object of the present invention is to allow a user of the cutting board to dry the board, after the washing of the board, in a manner that minimizes the contamination of the board from a kitchen or any other drying surfaces.

Another object of the present invention is to provide a cutting board that is easily handled.

### DRAWINGS

These and other features, aspects, and advantages of the present invention will become better understood with regard to the following description, appended claims, and drawings where:

FIG. 1 is a perspective view of a first embodiment of the ergonomic cutting board of the present invention;

FIG. 2A is a perspective view of the cutting board of FIG. 1 shown in the manner in which the embodiment is made to rest on a surface;

FIG. 2B is a left side view of the cutting board of FIG. 1;

FIG. 2C is a front view of the embodiment shown in FIG. 1, wherein the embodiment is on a flat surface and wherein the viewer is seeing the top of the board;

FIG. 3A is a left side view of another embodiment of the cutting board of the present invention;

FIG. 3B is a front view of the embodiment shown in FIG. 3A, wherein the embodiment is on a flat surface and wherein the viewer is seeing the top of the board;

FIG. 4A is a left side view of further embodiment of the cutting board of the present invention;

FIG. 4B is a front view of the embodiment shown in FIG. 4A, wherein the embodiment is on a flat surface and wherein the viewer is seeing the top of the board;

FIG. 5A is a left side view of yet further embodiment of the cutting board of the present invention;

FIG. 5B is a front view of the embodiment shown in FIG. 5A, wherein the embodiment is on a flat surface and wherein the viewer is seeing the top of the board; and

FIG. 5c is a perspective view of the embodiment shown in FIG. 5A, wherein the embodiment is on a flat surface and wherein the viewer is seeing the back of the board.

### DESCRIPTION

The following discussion describes in detail one embodiment of the invention and several variations of that embodiment. This discussion should not be construed as limiting the invention to that particular embodiment or to those particular variations. Practitioners skilled in the art will recognize numerous other embodiments and variations, as well. For a definition of a complete scope of the invention, the reader is directed to the appended claims.

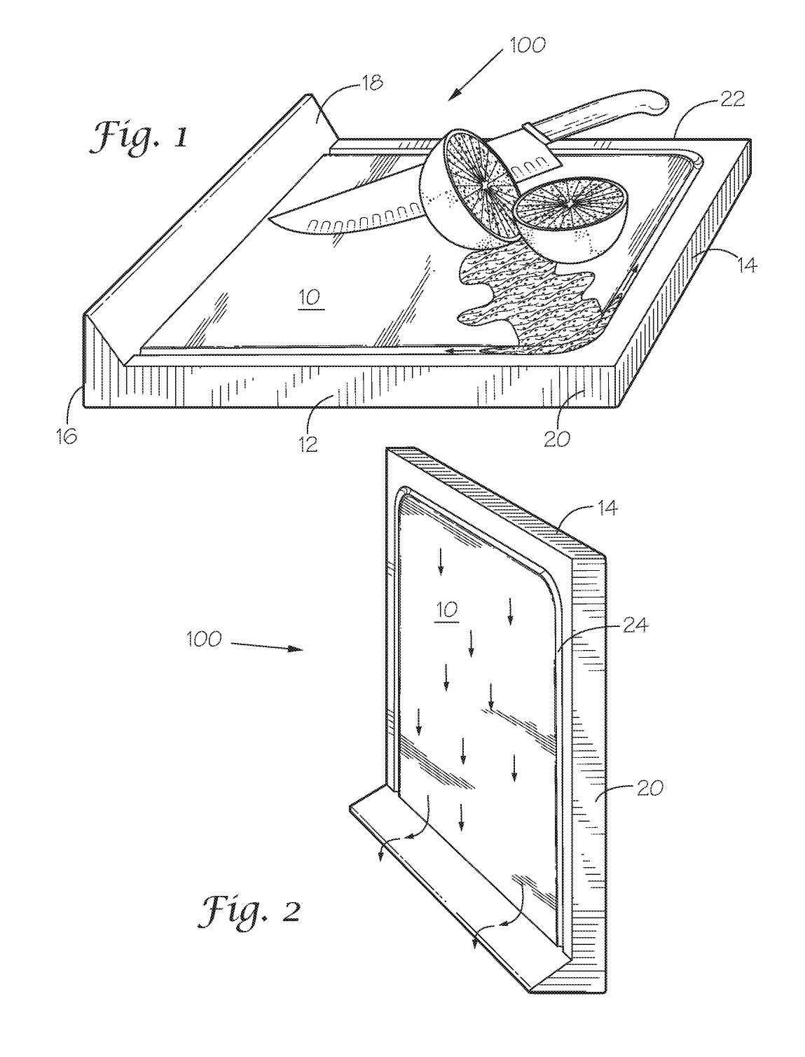

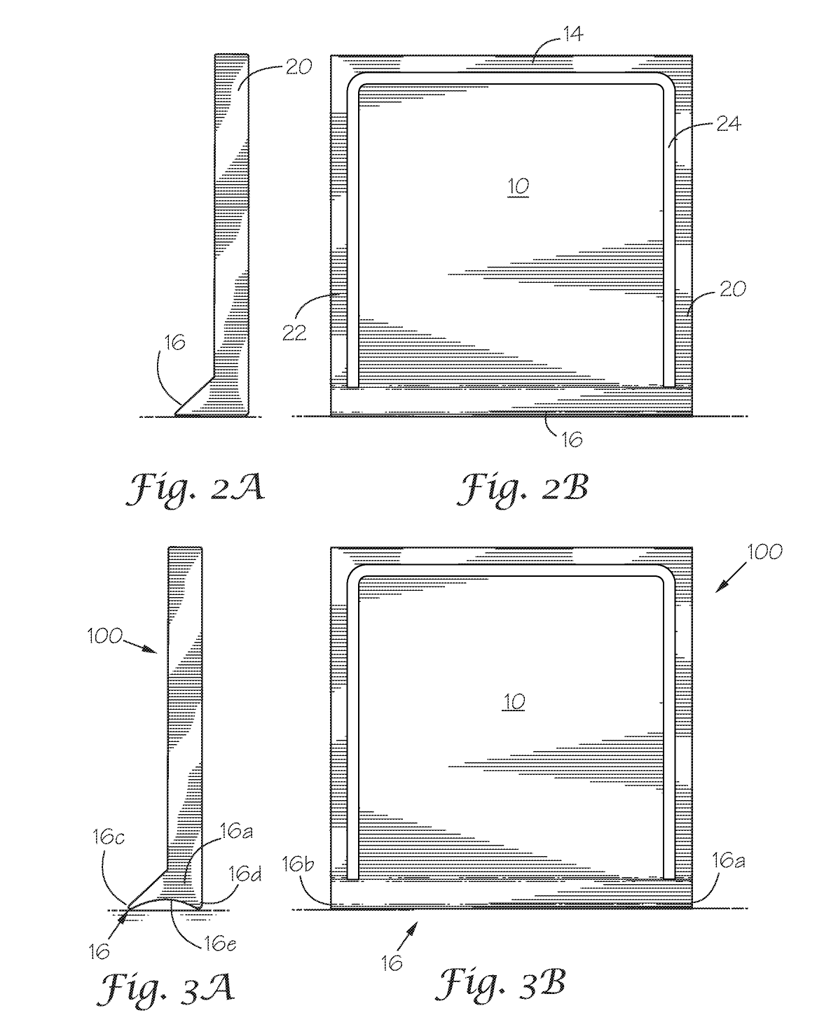

As seen in FIG. 1, an ergonomic cutting board of the present invention comprises a board 100, the board having a top 10, a bottom 12, a front 14, a rear 16, an acute 18, a left 20, and a right 22 side, the rear side 16 of the cutting board forms a perpendicular angle with the bottom side 12 of the board 100 and a forty five degree angle with the acute side 18 of the board 100, the acute side 18 of the board 100 and the top side 10 of the board form a one hundred and thirty five degree angle, the front 14 and the rear 16 sides of the board 100 are substantially parallel, the top 10 and the bottom 12 sides of the board 100 are substantially parallel, and the left 20 and right 22 sides of the board 100 are substantially parallel.

In preferred embodiments of the invention, the top side of the board might further define a channel 24 that runs adjacent to the left 20, front 14 and right sides 22 of the board 100 and that abuts the acute side 18 of the board 100.

As seen in FIGS. 3a-b, in another embodiment of the present invention, the rear side 16 of the board 100 has a left 16a, a right 16b, a top 16c and a bottom side 16d, and wherein the left 16a and the right 16b sides of the rear side 16 of the board 100 are parallel to each other and are arched 16e.

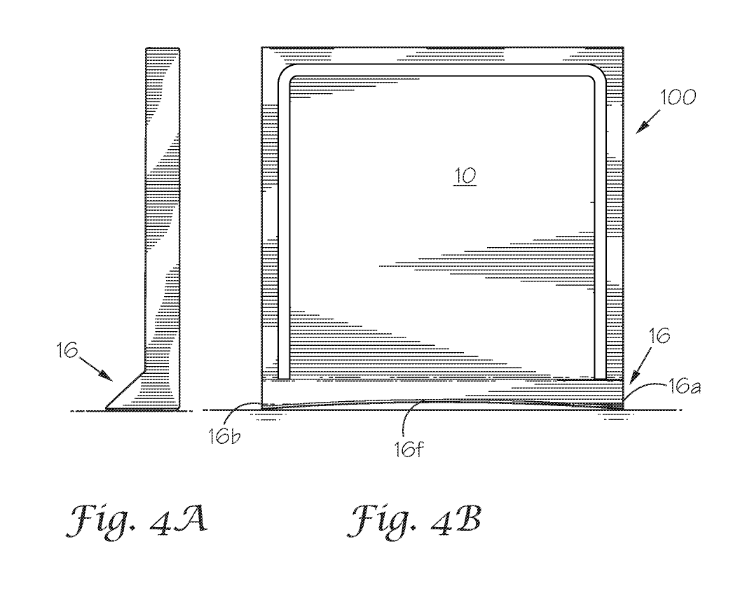

As seen in FIGS. 4a-b, in another embodiment of the present invention, the rear side of the board 16 has a left 16a, a right 16b, a top 16c and a bottom 16d side, and wherein the top 16c and bottom 16d sides of the rear side 16 of the board 100 are opposed to each other and are arched 16f.

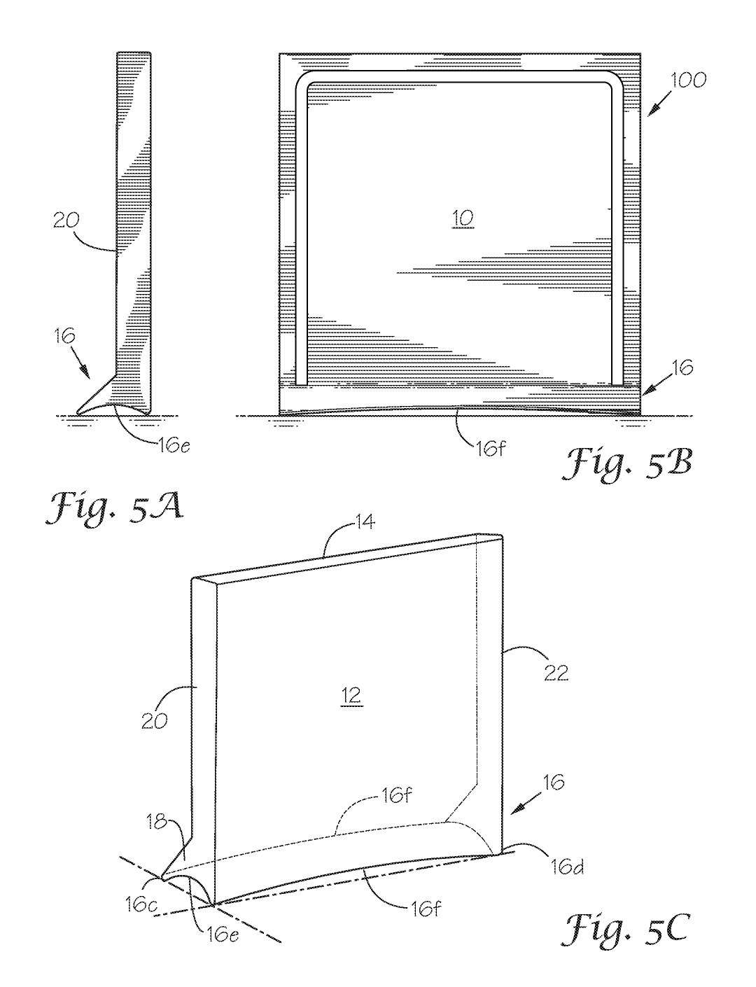

In a further embodiment of the present invention, as seen in FIGS. 5a-c, the rear side of the board has a left 16a, a right 16b, a top 16c and a bottom side 16d, and wherein the left 16a and the right 16b sides of the board are parallel to each other and are arched 16e, and wherein the top 16c and bottom 16d sides of the rear side 16 of the board 100 are opposed to each other and are arched 16f.

The ergonomic cutting board of the present invention is made of any material known in the art of making cutting boards.

In a preferred embodiment of the present invention, there is a distance between the top 10 and the bottom 12 sides of the board 100 of three quarters of an inch, not including the rear side 16 of the board 100.

The ergonomic cutting board 100 of the present invention is used as follows: first, providing a cutting board 100; next, providing a user; then, providing a surface; next, placing the bottom 12 of the cutting board 100 on the surface; then, having the user of the cutting board 100 place an item on the top 10 of the board 100 and then having the user cut the item; next, washing the cutting board 100; and lastly, drying the cutting board 100 by placing the rear side 16 of the cutting board 100 on the surface.

An advantage of the present invention is that it allows a user of the cutting board to dry the board, after the washing of the board, in a manner that minimizes the contamination of the board from a kitchen or any other drying surfaces.

An advantage of having the rear side of the cutting board to have arches is that the cutting boards footprint is minimized, thereby providing the maximum amount of drying surface.

Another advantage of the present invention is that provides a cutting board that is easily handled.

Although the present invention has been described in considerable detail in reference to preferred versions, other versions are possible. Therefore, the spirit and scope of the appended claims should not be limited to the description of the preferred versions contained herein.

What is claimed is:

1. An ergonomic cutting board, comprising a board, the board having a top, a bottom, a front a rear, an acute, a left, and a right side, the rear side of the cutting board forms a perpendicular angle with the bottom side of the board and a forty five degree angle with the acute side of the board, the acute side of the board and the top side of the board form a one hundred and thirty five degree angle, the front and the rear sides of the boar are substantially parallel, the top and the bottom sides of the board are substantially parallel, and the left and right sides of the board are substantially parallel.

2. The ergonomic board of claim 1, wherein the top side of the board defines a channel that runs adjacent to the left, front and right sides of the board and that abuts the acute side of the board.

3. The ergonomic board of claim 2, wherein the rear side of the board has a left, a right, a top and a bottom side, and wherein the left and the right sides of the rear side of the board are parallel to each other and are arched.

4. The ergonomic board of claim 3, wherein the top and bottom sides of the rear side of the board are opposed to each other and are arched.

5. The ergonomic board of claim 2, wherein the rear side of the board has a left, a right, a top and a bottom side, and wherein the top and bottom sides of the rear side of the board are opposed to each other and are arched.

6. The ergonomic board of claim 5, wherein the left and the right sides of the rear side of the board are parallel to each other and are arched.

7. The ergonomic board of claim 1, wherein the rear side of the board has a left, a right, a top and a bottom side, and wherein the left and the right sides of the rear side of the board are parallel to each other and are arched.

8. The ergonomic board of claim 7, wherein the top and bottom sides of the rear side of the board are opposed to each other and are arched.

9. The ergonomic board of claim 1, wherein the rear side of the board has a left, a right, a top and a bottom side, and wherein the top and bottom sides of the rear side of the board are opposed to each other and are arched.

10. The ergonomic board of claim 9, wherein the left and the right sides of the rear side of the board are parallel to each other and are arched.

11. A method of using the cutting board of claim 1, comprising the steps of:
providing a cutting board;
providing a user;
providing a surface;
placing the bottom of the cutting board on the surface; and
having the user of the cutting board place an item on the top of the board and then
having the user cut the item.

12. The method of claim 11, further comprising the steps of:
washing the cutting board; and
then, drying the cutting board by placing the rear side of the cutting board on the surface.
